(19) United States
(12) Patent Application Publication
(10) Pub. No.: US 2008/0173143 A1
(43) Pub. Date: Jul. 24, 2008

(54) Universal Pliers

(76) Inventor: Ming-Chieh Wu, Taichung (TW)

Correspondence Address: Dr. BANGER SHIA, 102 Lindencrest Ct., Sugar Land, TX, 77479-5201, US

(21) Appl. No.: 11/839,154

(22) Filed: Aug. 15, 2007

Related U.S. Application Data
(63) Continuation-in-part of application No. 11/625,399, filed on Jan. 22, 2007, now abandoned.

(51) Int. Cl. B25B 7/00

(52) U.S. Cl. 81/300

(57) ABSTRACT

A pair of universal pliers comprises a first plier body, a second plier body, an extension spring, an adjusting rod, a linkage bar and a turning rod. A pivot point where the second handle is pivotally coupled to the second jaw, an end point of the arc-shaped groove, and the other end point of the arc-shaped groove are arranged on the same straight line, so that no matter the pivot pin is positioned at either end point of the arc-shaped groove, it ensures that the first jaw is opened or closed horizontally with respect to the second jaw. Consequently, it doesn't only have a wide application range, but also the tense operation of the extension spring is helpful to clamping a work piece in a surface-to-surface manner, thus ensuring a firm clamping operation against slippage.

This application is a continuation of part of U.S. patent application Ser. No. 11/625,399. filed on Jan. 22, 2007, which claims the benefit of the earlier filing date.

### BACKGROUND OF THE INVENTION

1. Field of the Invention

The present invention relates to a pair of universal pliers and more particularly to an improved structure for a pair of universal pliers that is applied widely and can firm clamp a work piece.

2. Description of the Prior Art

A pair of conventional universal pliers (as shown in FIG. 1) comprises a first plier body 11, a second plier body 12, an extension spring 13, an adjusting rod 14, a linkage bar 15 and a turning rod 16. Since the first body 11 and the second body 12 are connected with each other through a pivot pin 17, the maximum open angle between the first plier body 11 and the second plier body 12 will be quite limited, and the size range of a work piece W capable of being clamped is quite confined, namely there is no problem in clamping a small size work piece W, but to a big work piece W, whose size exceeds the clamping range, the conventional universal pliers cannot be applied. Thus, several pairs of conventional universal pliers capable of being applied to some different size ranges must be prepared in order to clamp different sized work pieces, so it is quite inconvenient in use. Afterwards, a pair of universal pliers capable of being applied to different size range work pieces was developed, but because the universal pliers can't clamp firm after being changed to different working sizes and it is likely to jump from a working size to another working size suddenly by an excessive force applied during the operating process. So the effect of clamping a work piece is not good, and the practicality is not fine.

The present invention has arisen to mitigate and/or obviate the afore-described disadvantages.

### SUMMARY OF THE INVENTION

The primary objective of the present invention is to provide a pair of universal pliers. A pivot point where the second handle is pivotally coupled to the second jaw, an end point of the arc-shaped groove, and the other end point of the arc-shaped groove are arranged on the same straight line, so that no matter the pivot pin is positioned at either end point of the arc-shaped groove, it ensures that the first jaw is opened or closed horizontally with respect to the second jaw. Thereby, it is helpful to clamping a work piece in a surface-to-surface manner, thus ensuring a firm clamping operation against slippage.

The second objective of the present invention is to provide a pair of universal pliers. A pivot pin disposed in a position where a first plier body is pivotally coupled to a second plier body is allowed to move in an arc-shaped groove. Accordingly, when the pivot pin is positioned in a stopping portion of the arc-shaped groove, thus a work piece capable of being clamped is small; but when the pivot pin is positioned in another end of the arc-shaped groove far away from the stopping portion, thus a work piece capable of being clamped is large. Consequently, it really has a wide application range.

The third objective of the present invention is to provide a pair of universal pliers, wherein, the pivot pin provided for pivotally coupling the first plier body to the second plier body is allowed to move in the arc-shaped groove. Since the arc-shaped groove is formed with a stopping portion, in addition, the pivot pin is under the tense operation of an extension spring, the pivot pin is confined by the stopping portion when it is positioned in a position. So that it is not likely to slip out of the position by a force when clamping a work piece, consequently, ensure a firm clamping of the work piece against any loose situation.

### BRIEF DESCRIPTION OF THE DRAWINGS

FIG. 1 is a plan view of a pair of conventional universal pliers;

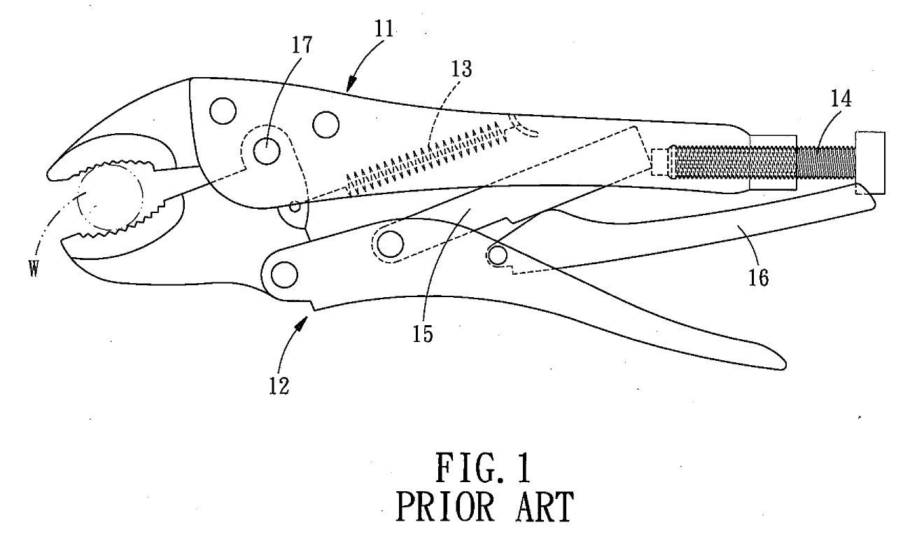

FIG. 2 shows a plan view of a pair of universal pliers in accordance with the prevent invention are clamping a relatively small size work piece; and

FIG. 3 shows a plan view of the universal pliers in accordance with the prevent invention are clamping a relatively large size work piece.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

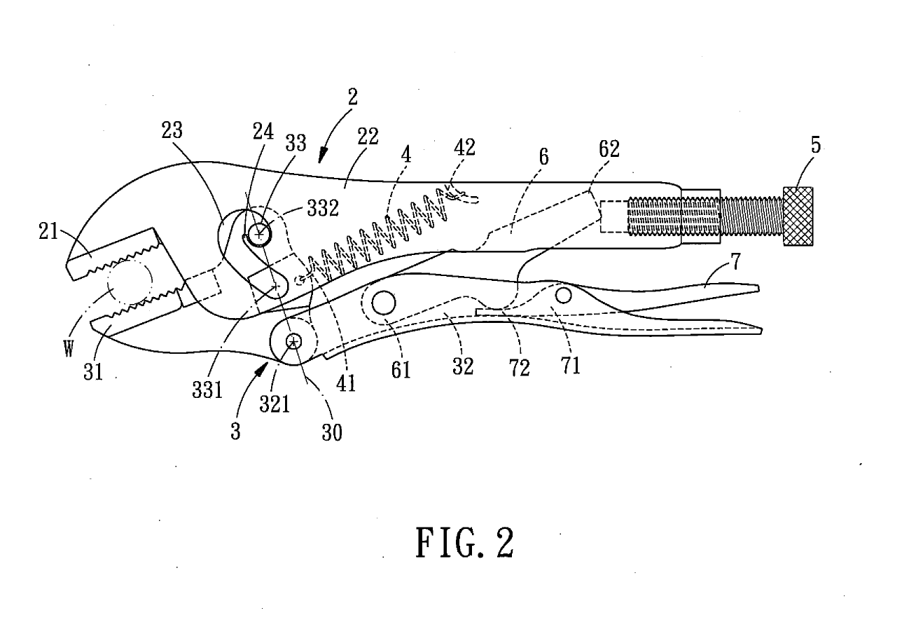

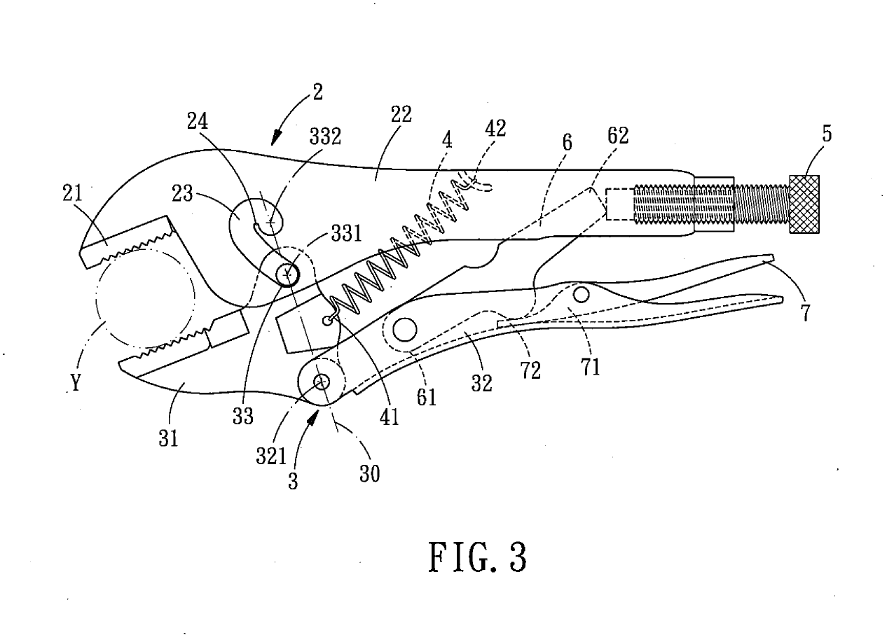

A pair of universal pliers in accordance with the preferred embodiment of the present invention (please refer to FIGS. 2-3) comprises a first plier body 2, a second plier body 3, an extension spring 4, an adjusting rod 5, a linkage bar 6 and a turning rod 7.

The first plier body 2 includes a first jaw 21 integral with a hollow first handle 22, namely the first jaw 21 is connected with one end of hollow handle 22 after the first plier body 2 is formed. It is to be noted that, in each side of the hollow first handle 22 of the first plier body 2 is oppositely formed an arc-shaped groove 23, and each arc-shaped groove 23 is formed with a stopping portion 24.

The second plier body 3 includes a second jaw 31 and a hollow second handle 32. The second jaw 31 is pivotally coupled in the arc-shaped grooves 23 by a pivot pin 33. After the first plier body 2 and the second plier body 3 are assembled together, the first jaw 21 and the second jaw 31 will be opposite to each other. Moreover, the hollow first handle 22 is pivotally coupled to the second jaw 31. It is to be noted that, in order to ensure that the first jaw 21 is always parallel to the second jaw 31, a pivot point 321 where the second handle 32 is pivotally coupled to the second jaw 31, an end point 33 1 of the arc-shaped groove 23, and the other end point 332 of the arc-shaped groove 23 are arranged on the same straight line 30.

The extension spring 4, one end 41 of which is fastened to the second jaw 31 and the other end 42 of which is fastened to the hollow first handle 22 of the first plier body 21.

The adjusting rod 5 is movably screwed in the other end of the hollow first handle 22 of the first plier body 2.

The linkage bar 6, one end 61 of which is pivotally coupled to the hollow second handle 32, the other end 62 of which is positioned in a hollow portion of the hollow first handle 22, and which can be driven to move back and forth by the adjusting rod 5.

The turning rod 7 is mounted under the linkage bar 6. One end 71 of the turning rod 7 is pivotally coupled to the hollow second handle 32, and on the turning rod 7 adjacent to a pivot end is formed a push portion 72 provided for contacting the linkage bar 6 at appropriate time.

The aforementioned is the summary of the positional and structural relationship of the respective components of the preferred embodiment in accordance with the present invention.

Because the operation principle of the universal pliers of clamping a work piece of is the same as the conventional pliers, further explanations will be omitted. As for additional applicable range, the use state of firm clamping a work piece and the function of the present invention, please refer to FIG. 2 and FIG. 3, the second jaw 31 is pivotally coupled in the arc-shaped groove 23 of the first plier body 2, and the arc-shaped groove 23 is formed with the stopping portion 24. In order to adjust the universal pliers to make it fit for different sized work pieces, the pivot pin 33 should be moved to the arc-shaped groove 23 first, and then clamping action can be performed. The pivot pin 33 can be moved simply by overcoming the elastic force of the extension spring 4. When the pivot pin 33 is positioned in the stopping portion 24 of the arc-shaped groove 23, the open angle between the first jaw 21and the second jaw 31 is minimum, thus the pliers can only clamp a relatively small work piece W. In addition, when the pivot pin 33 is moved out of the stopping portion 24 after overcoming the elastic force of the stopping portion 24 and is positioned in another end of the arc-shaped groove 23 far away from the stopping portion 24, the open angle between the first jaw 21and the second jaw 31 will become relatively large, at this time the size of a work piece Y capable of being clamped will be larger than that of the wok piece W. So the present invention really has a wider application range. It is to be noted that, since the extension spring 4 keeps pulling the second jaw 31 upwards all the time, and the pivot pin 33 is synchronously kept being pulled downwards, so that, after adjustment, the pivot pin 33 is confined by the stopping portion 24, while being kept pulled downwards by the extension spring 4. So that the pivot pin 33 is not likely to slip out of the position by force when clamping the work pieces W, Y, consequently, ensuring a firm clamping of the work pieces W, Y.

It is to be noted that, the pivot point 321 where the second handle 32 is pivotally coupled to the second jaw 31, an end point 331 of the arc-shaped groove 23, and the other end point 332 of the arc-shaped groove 23 are arranged on the same straight line 30, so that no matter the pivot pin 33 is positioned at either the point 331 or the point 332 of the arc-shaped groove 23, it can ensure that the first jaw 21 is opened or closed horizontally with respect to the second jaw 31. Thereby, it is helpful to clamping a work piece in a surface-to-surface manner, thus ensuring a firm clamping operation against slippage.

What is claimed is:

1. A pair of universal pliers comprising:
a first plier body including a first jaw integral with a hollow first handle, the first jaw being connected with one end of the first handle, each side of the hollow first handle being oppositely formed with an arc-shaped groove and each arc-shaped groove is formed with a stopping portion;
a second plier body including a second jaw and a hollow second handle, the second jaw is pivotally coupled in the arc-shaped grooves of the first plier body by a pivot pin, after the first plier body and the second plier body are assembled together, the first jaw and the second jaw will be opposite to each other, the hollow first handle is pivotally coupled to the second jaw, the pivot pin is movable in the arc-shaped grooves, when the pivot pin is positioned in the stopping portion, a work piece capable of being clamped is small, and when the pivot pin is positioned in another end of the arc-shaped groove far away from the stopping portion, a work piece capable of being clamped is large;
an extension spring, one end of which is fastened to the second jaw of the second plier body and the other end of which is fastened to the hollow first handle of the first plier body;
an adjusting rod being movably screwed in the other end of the first handle;
a linkage bar, one end of which is pivotally coupled to the hollow second handle, the other end of which is positioned in hollow portion of the hollow first handle, and the linkage bar is driven to move back and forth by the adjusting rod;
a turning rod being mounted under the linkage bar, one end of the turning rod being pivotally coupled to the hollow second handle, and on the turning rod adjacent to a pivot end being formed a push portion for contacting the linkage bar at appropriate time;
the pair of universal pliers is characterized in that: a pivot point where the second handle is pivotally coupled to the second jaw, an end point of the arc-shaped groove, and the other end point of the arc-shaped groove are arranged on the same straight line, so that no matter the pivot pin is positioned at either end point of the arc-shaped groove, it ensures that the first jaw is opened or closed horizontally with respect to the second jaw.
